(19) United States
(12) Patent Application Publication
(10) Pub. No.: US 2006/0103689 A1
(43) Pub. Date: May 18, 2006

(54) Method for splitting a print image data plane for printing with multiple printheads

(76) Inventors: Santiago Garcia-Reyero Vinas, San Diego, CA (US); Cesar Fernandez Espasa, San Diego, CA (US); Joan Vidal Fortia, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/993,035

(22) Filed: Nov. 18, 2004

(51) Int. Cl. B41J 2/205

(52) U.S. Cl. 347/15

(57) ABSTRACT

A method for splitting a print image data plane for printing with multiple printheads includes replicating the print image data plane into a plurality of print image data planes corresponding to the multiple printheads, linearizing the plurality of print image data planes, and half-toning the plurality of print image data planes, the half-toning being configured to convert the plurality of print image data planes into a n-plane image with interlaced columns, wherein n corresponds to the multiple printheads.

### BACKGROUND

Inkjet printing systems are in common use today. An inkjet printer forms a printed image by printing a pattern of individual dots at particular locations of an array defined for the printing medium. The locations are conveniently visualized as being small dots in a rectilinear array. The locations are sometimes “dot locations”, “dot positions”, or “pixels.” Thus, the printing operation can be viewed as the filling of a pattern of dot locations with dots of ink.

Inkjet printers print dots by ejecting very small drops of ink onto the print medium, and may include a movable carriage that supports one or more printheads, each printhead having ink ejecting nozzles. During operation, the carriage traverses over the surface of the print medium and the nozzles are controlled to eject drops of ink at appropriate times pursuant to command of a microcomputer or other controller, wherein the timing of the application of the ink drops is intended to correspond to the pattern of pixels of the image being printed.

Color inkjet printers commonly employ a plurality of printheads, for example four, mounted in the print carriage to produce different colors. Each printhead contains ink of a different color, with the commonly used colors being cyan, magenta, yellow, and black. These base colors are produced by depositing a drop of the essential color onto a dot location. Secondary or shaded colors are formed by depositing drops of different colors on adjacent dot locations; the human eye interprets the color mixing as the secondary or shading, through well known optical principles.

Additionally, a number of inkjet printers include fixed inkjet printheads that remain stationary rather than traversing the surface of a desired print medium. Fixed inkjet printheads include a printhead having a print height that covers the entire height of an image to be produced. Consequently, fixed inkjet printheads receive image data and transport the print medium adjacent to the fixed printhead. As the print medium is controllably transported adjacent to the fixed printhead, drops of ink are selectively ejected from the printhead to form the desired image.

Fixed printheads may be utilized, for example, in high-speed printers. A physical constraint on the maximum printing speed in inkjet printers is the maximum rate at which the pen may be electrically “fired”. One way to overcome this constraint is to allocate the printing function to multiple printheads. Generating the appropriate data for each printhead can be a computationally intensive task, however, resulting in a need for methods of efficiently generating such data

### SUMMARY

A method for splitting a print image data plane for printing with multiple printheads includes replicating the print image data plane into a plurality of print image data planes corresponding to the multiple printheads, linearizing the plurality of print image data planes, and half-toning the plurality of print image data planes, the half-toning being configured to convert the plurality of print image data planes into a n-plane image with interlaced columns, wherein n corresponds to the multiple printheads.

### BRIEF DESCRIPTION OF THE DRAWINGS

The accompanying drawings illustrate various embodiments of the present method and system and are a part of the specification. The illustrated embodiments are merely examples of the present system and method and do not limit the scope thereof.

FIG. 1 is a simple block diagram illustrating the components of a fixed inkjet printing system, according to one exemplary embodiment.

FIGS. 2A and 2B are simple block diagrams illustrating the controlling components of a fixed inkjet printing system, according to one exemplary embodiment.

FIG. 3 is a flow chart illustrating an exemplary method for forming a plurality of interlaced images, according to one exemplary embodiment.

Throughout the drawings, identical reference numbers designate similar, but not necessarily identical, elements.

### DETAILED DESCRIPTION

A system and a method for splitting an image into a plurality of autonomous, interlaced images using existing data pipeline components are described herein. More specifically, the present system and method incorporates specific algorithms found in traditional data pipeline application specific integrated circuits (ASIC) to perform plane splitting operations in hardware, thereby reducing the computational load on a printing system's central processing unit (CPU). Once the image data is split into a plurality of interlaced images, multiple printheads may be used to simultaneously print a single desired image, thereby increasing the potential print speed. Further, the use of existing hardware and algorithms reduces the time and expense associated with implementing the present system and method. A number of exemplary structures and methods for splitting an image into a plurality of interlaced images are described in detail below.

As used in this specification and in the appended claims, the term “ink” is meant to be understood broadly as any jettable fluid, with or without colorant that may be selectively ejected by any number of inkjet printing devices. Additionally, the term “jettable” is meant to be understood as a fluid that has a viscosity suitable for precise ejection from an inkjet printing device. Moreover, the term “dots per inch” or “dpi” is meant to be understood broadly as a measure of the resolution produced by a printing device.

In the following description, for purposes of explanation, numerous specific details are set forth in order to provide a thorough understanding of the present system and method for splitting an image into a plurality of autonomous, interlaced images. It will be apparent, however, to one skilled in the art that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

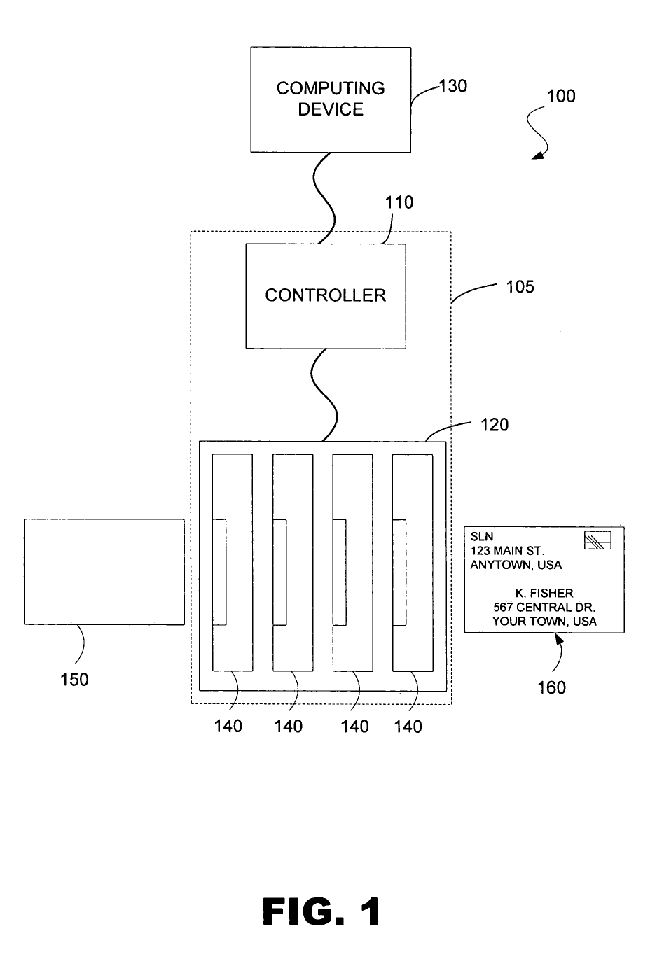

FIG. 1 illustrates an exemplary inkjet printing system (100) configured to incorporate the present method for splitting an image into a plurality of autonomous, interlaced images, according to one exemplary embodiment. As show in FIG. 1, the exemplary inkjet printing system (100) may include an inkjet printer (105) having a print medium (150) disposed thereon. Additionally, a computing device (130) may be communicatively coupled to the inkjet printer (105) to generate and provide images to be printed by the inkjet printing system (105).

As shown in FIG. 1, the inkjet printer (105) of the inkjet printing system (100) may be any shape or size sufficient to house a plurality of fixed inkjet printheads (140) and any associated hardware configured to perform the present method of splitting an image into a plurality of autonomous, interlaced images. As shown, the inkjet printer (105) may include a controller (110) and a fixed printhead housing (120) configured to house a plurality of fixed inkjet printheads (140). Additionally, the inkjet printer (105) may contain any number of material dispensers, material reservoirs, print medium positioning rollers or belts, servo mechanisms, and/or computing devices configured to facilitate the present method, as explained in further detail below.

According to one exemplary embodiment, the inkjet printing system (100) may generate and/or receive a print job from the communicatively coupled computing device (130), wherein the print job includes a digital description of a desired image. The computing device (130) coupled to the inkjet printer (105) may include any data processing device including, but in no way limited to, a personal computer (PC), a workstation, a laptop computer, a networked computer system, and the like.

As shown in FIG. 1, the exemplary inkjet printer (105) that receives the print job from the computing device (130) includes a fixed printhead housing (120) that supports and protects the fixed inkjet printheads (140). While the present method may be employed by an inkjet printer having any number or variety of inkjet printheads, for ease of explanation only, the present system and method will be describe in the context of an inkjet printer that includes four fixed inkjet printheads (140). According to one exemplary embodiment, the fixed inkjet printheads (140) incorporated by the present inkjet printer (105) may be any type of inkjet capable of performing print on demand applications including, but in no way limited to, thermally activated inkjet material dispensers, mechanically activated inkjet material dispensers, electrically activated inkjet material dispensers, magnetically activated material dispensers, and/or piezoelectrically activated material dispensers. Additionally, the inkjet printing system (100) may include one or more material reservoirs (not shown) configured to supply ink to the fixed inkjet printheads (140). The material reservoirs (not shown) may be, according to various exemplary embodiments, on-axis or off-axis material reservoirs. Moreover, any number of print mediums (150) may be used by the present system and method including, but in no way limited to, paper, plastic, transparencies, fabric, and the like.

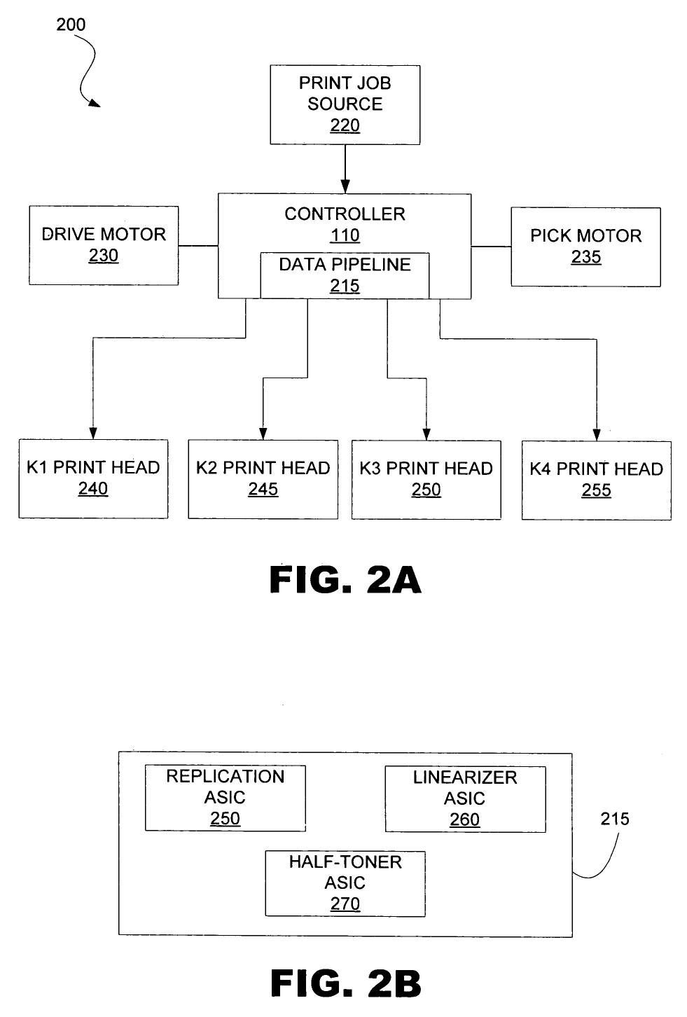

Once generated by the computing device (130), the digital description is then further computed into a series of dispensing commands that are then used by the inkjet printer (105) to control the deposition of jettable image forming material from the fixed inkjet printheads (140) onto the print medium (150), thereby forming a printed image (160) thereon. Further computation of the digital description may occur in the computing device as well as in the controller (110) that forms a portion of the inkjet printer (105). FIG. 2A illustrates a control system (200) incorporated into the inkjet printing system (100) which may perform further computation of the digital image description, according to one exemplary embodiment. All or merely portions of the control system (200) may reside on the inkjet printing system (100).

As illustrated in FIG. 2A, the control system (200) includes a controller (110), that may include a microcomputer or a plurality of ASICs, that receive print job commands and data from a print job source (220), such as the computing device (130; FIG. 1). According to one exemplary embodiment, the controller (110) implements functions of a print data pipeline (215). A print data pipeline (215) is a command or process chain effected on received print data, wherein an output of one program or algorithm is used as an input of another. According to the present exemplary embodiment, as illustrated in FIG. 2A, the data pipeline (110), in conjunction with the controller (110), controls the operation of the drive motor (230) and a pick roller motor (235) that regulates the supply of print medium (150; FIG. 1) to and through a print zone of the inkjet printer (105; FIG. 1). The controller (110) is programmed to incrementally advance the print medium (150; FIG. 1) through a print zone adjacent to the printheads (240-255), to incrementally receive a printed image, and to eject the printed medium (160; FIG. 1) once completed. Furthermore, the data pipeline (215) modifies the received print data, allocates portions of the print data to various printheads (240-255), and produces commands for firing pulses that are sent to the multiple printheads.

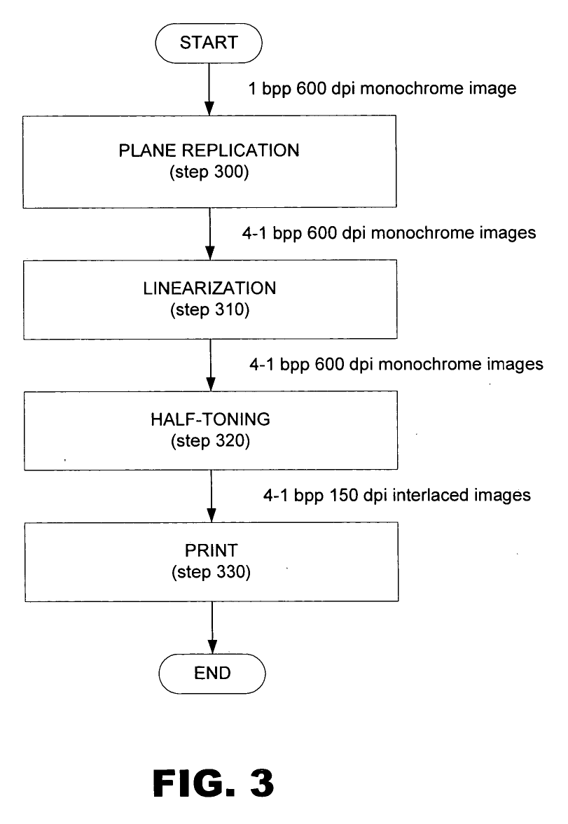

FIG. 2B illustrates a number of ASIC applications that are traditionally present in the data pipeline (215). As illustrated in FIG. 2B, the data pipeline (215) may include, but is in no way limited to, a replication ASIC block (250), a linearizer ASIC block (260), and a half-toner ASIC block (270). According to traditional uses, the replication ASIC block (250) is used to replicate or copy print image data for the application of a surface treatment, such as a fixer, onto a printed image. Additionally, the algorithms performed by a linearizer ASIC block (260) are traditionally used to linearize or standardize the grayscale steps of an exposed pixel so that the resulting gray levels correspond to a uniform increase in exposure dose for each successive level. Furthermore, the algorithms incorporated in a half-toner ASIC block (270) are traditionally used to reduce or otherwise vary the size or density of the dots emitted by a printhead to create printing shades. In contrast to the traditional uses illustrated above, the present system and method leverages the functionality of the existing ASICs to split an image into a plurality of autonomous, interlaced images that may then be used to print the desired image at high speeds, as will be further described in detail below with reference to FIG. 3.

Exemplary Implementation and Operation

During typical operation of a fixed inkjet printer (105; FIG. 1), high speed printing utilizes different pens in order to print a complete set of image data without firing each pen above its electrical limits. That is, traditional inkjet printheads are limited to 300 feet/minute when printing a 600 dpi x 600 dpi image at 36 kHz. In order to print at a higher rate, the inkjet printing system (100; FIG. 1) splits the image data into interlaced columns that are then allocated to the different stationary printheads (240-255; FIG. 2A). Once the image is split, a single-plane image has been converted into a n-plane image with interlaced columns (where n is the number of pens that print the same area). The data pipeline (215; FIG. 2) then sends the first plane of the print image data to a first print head (240; FIG. 2A), the second plane to a second print head (245; FIG. 2A), and so on. Performing this plane splitting operation in software consumes a high amount of CPU resources.

However, there are no specific algorithms currently in the traditional data pipeline ASIC configured to perform the plane splitting operation. Rather, traditional methods either applied the plane splitting algorithm in software or created an ASIC dedicated to performing the plane splitting algorithm in hardware. However, performing the plane splitting algorithm in software often requires an upgrade of the printer's processor, due to the high computational demands, and creating a new ASIC just for performing the plane splitting algorithm is prohibitively expensive for most systems.

FIG. 3 illustrates a method for splitting a single image data plane into a plurality of autonomous, interlaced image data planes using existing data pipeline components and algorithms, according to one exemplary embodiment. As illustrated in FIG. 3, the present exemplary method for splitting an image into a plurality of autonomous, interlaced image data planes begins by performing a plane replication operation on a desired print image data plane (step 300), followed by a linearization of the replicated print image data planes (step 310). Once linearized, a half-toner operation is performed on the print image data planes (step 320) before being printed (step 330) by a plurality of printheads. Further details of the exemplary method illustrated in FIG. 3 will be given below, with reference to FIG. 3. As explained below, the exemplary method will be described in the context of transforming a 1 bpp, 600 dpi image data plane into four 1 bpp, 150 dpi image data planes for printing by a 4 fixed inkjet printheads.

As illustrated in FIG. 3, the present exemplary method begins by performing a plane replication operation on received print image data (step 300). As illustrated in FIG. 3, the exemplary print image data received by the data pipeline (215; FIG. 2) is a 1 bpp, 600 dpi monochrome print image data plane.

According to the present exemplary embodiment, the plane replication block (250; FIG. 2B) or algorithm of the print data pipeline (215; FIG. 2B) ASIC is programmed to process the monochrome print image data plane and fill the cyan-yellow-magenta (CYM) resulting planes by copying each and every byte of the original monochrome print image data plane. Consequently, the CYM print image data planes will be filled with 4 print data images that are exactly identical to the original monochrome (K) print data image.

Once the plane replication has been performed (step 300), four exactly identical 1 bpp, 600 dpi monochrome print image data planes are present. These four identical print image data planes are then processed by a linearization block (step 310) or algorithm of the print data pipeline (215; FIG. 2B). According to the present exemplary embodiment, the linearizer block (260; FIG. 2B) is used to prepare the separation of the four resulting print image data planes as illustrated by Tables 1-4 below.

According to one exemplary embodiment, the linearization block (260; FIG. 2B) of the print data pipeline (215; FIG. 2B) ASIC includes a look-up table with 256 eight-bit inputs and 256 twelve-bit outputs. Using the look-up table, each value entering the linearization block (260; FIG. 2B) is replaced by its corresponding value on the look-up table. Additionally, each of the identical monochrome image planes has its own table.

By way of example only, a first printhead (240; FIG. 2A) may be assigned to the C plane of the CYMK color model. For the C plane the following table may be used for linearization by the linearizer block (260; FIG. 2B) (where ‘_’ corresponds to any binary value of ‘0’ or ‘1’):

TABLE 1

| | |
|---|---|
| ___0___0_{b} | 000ₕ |
| ___0___1_{b} | 3F0ₕ |
| ___1___0_{b} | 7F0ₕ |
| ___1___1_{b} | BF0ₕ |

For a second printhead (245; FIG. 2A) that is assigned to the M plane of the CYMK color model, the following table may be used:

TABLE 2

| | |
|---|---|
| __0___0__{b} | 000ₕ |
| __0___1__{b} | 3F0ₕ |
| __1___0__{b} | 7F0ₕ |
| __1___1__{b} | BF0ₕ |

For a third printhead (250; FIG. 2A) that is assigned to the Y plane of the CYMK color model, the following table may be used:

TABLE 3

| | |
|---|---|
| _0___0___{b} | 000ₕ |
| _0___1___{b} | 3F0ₕ |
| _1___0___{b} | 7F0ₕ |
| _1___1___{b} | BF0ₕ |

And for a fourth printhead (255; FIG. 2A) that is assigned to the K plane of the CYMK color model, the following table may be used:

TABLE 4

| | |
|---|---|
| 0___0____{b} | 000ₕ |
| 0___1____{b} | 3F0ₕ |
| 1___0____{b} | 7F0ₕ |
| 1___1____{b} | BF0ₕ |

As a result of the above linearization, the four linearized 1 bpp, 600 dpi monochrome image data planes result.

After the linearization process (step 310) has been performed, the half-toner block (270; FIG. 2B) in the print data pipeline (215; FIG. 1A) ASIC is used to process the resulting print image data planes (step 320). The half-toner block (270; FIG. 2B) in the ASIC reduces the 8 bit linearized values of the print image data planes to 1, 2, 3 or 4 HiFipe bits. Hifipe bits are to be understood as the output of the half-toning process. According to a number of exemplary embodiments, the HiFipe bits output by the half-toner block (270; FIG. 2B) can be binary: 1 bit for each pixel—‘0’ or ‘1’. HiFipe: 2 (or more) bits per pixel. In a 2-bit HiFipe pipeline the output is a 2 bit value per pixel (so values of ‘0’, ‘1’, ‘2’ or ‘3’), in a 3-bit HiFipe every pixel have values from ‘0’ to ‘7’, etc.

In the present exemplary embodiment, the matrix half-toner algorithm is used and every 8 bit word (discarding the least significant nibble or half byte—four bits) is transformed into two HiFipe bits, 1 HiFipe bit per pixel. While the present exemplary embodiment uses the matrix half-toner algorithm, any number of half-toning algorithms may be used including, but in no way limited to, matrix, Floyd-Stienberg FED, PDFED (Plane dependent Fast Error Diffusion) and TDFED (Tone Dependent Fast Error Diffusion).

According to the present exemplary embodiment, the half-toner block (270; FIG. 2B) functions as if it is converting each of the 8 bit pixels of the print image data planes into one 2 bit HiFipe pixel. However, since four interlaced print image data planes are being processed by the half-toner block (270; FIG. 2B), the half-toner block (270; FIG. 2B) is actually splitting the information merged by the linearizer (260; FIG. 2B). Continuing with the above example, the conversion values implemented by the half-toner block (270; FIG. 2B) are illustrated in the following table (Note that [x, y] means all the values z that x_z_y):

TABLE 5

| | |
|---|---|
| [00ₕ, 3Eₕ] | 00_{b} |
| [3Fₕ, 7Eₕ] | 01_{b} |
| [7Fₕ, BEₕ] | 10_{b} |
| [BFₕ, FFₕ] | 11_{b} |

As a result of the half-toner operation (step 310), a 4 plane image with ¼ of the resolution of the original image is produced. Additionally, the columns of the 4 print image data planes are interlaced for transmission to each of the four stationary inkjet printheads (240-255; FIG. 2B). Once the four 1 bpp, 150 dpi interlaced print image data planes are produced, they are selectively transmitted to their corresponding stationary inkjet printheads (240-255; FIG. 2A) and a print operation is performed. As previously mentioned, the interlacing of the monochrome image allows each of the stationary inkjet printheads to print a portion of the desired image, permitting the inkjet printer (105; FIG. 1) to produce a printed image (160; FIG. 1) in a quarter of the time possible with a single stationary inkjet printhead.

While the above-mentioned system and method were described in the context of a fixed inkjet printer having four fixed inkjet printheads, the present method may be incorporated by an inkjet printer having a plurality of fixed inkjet printheads. Furthermore, the present method may also be employed by an inkjet printing apparatus having a plurality of translating printheads, according to one exemplary embodiment.

In conclusion, the present system and method for splitting an image into a plurality of autonomous, interlaced images uses existing data pipeline components to perform the image splitting operation in hardware. More specifically, the present system and method alleviates use of a high amount of CPU resources by performing the image splitting function in existing data pipeline hardware components and algorithms of the controller. Specifically, the existing plane replication, linearization, and half-toning algorithms of the data pipeline ASIC are used to form four interlaced print data image planes.

The preceding description has been presented only to illustrate and describe exemplary embodiments of the present system and method. It is not intended to be exhaustive or to limit the present system and method to any precise form disclosed. Many modifications and variations are possible in light of the above teaching. It is intended that the scope of the present system and method be defined by the following claims.

What is claimed is:

1. A method for printing ink drops from an inkjet printing system having a plurality (n) of inkjet print heads comprising:
receiving print data from a print job source including a print image data plane;
replicating the print image data plane into a plurality of print image data planes corresponding to the plurality of inkjet printheads;
linearizing said plurality of print image data planes; and
half-toning said plurality of print image data planes;
said half-toning being configured to convert said plurality of print image data planes into a n-plane image with interlaced columns.

2. The method of claim 1, wherein said received print data comprises data representing a monochrome image.

3. The method of claim 1, wherein said step of replicating print image data comprises:
copying each byte of said received print image data plane; and
generating a replica of said received print image data plane (K) in each of a cyan, a yellow, and a magenta (CYM) resulting plane.

4. The method of claim 1, wherein said step of linearizing said plurality of print image data planes comprises:
receiving a plurality of print image data planes;
replacing each value of said plurality of print image data planes with a corresponding value from a lookup table;
wherein each of said plurality of print image data planes has a corresponding lookup table, said corresponding lookup tables being configured to separate said plurality of print image data planes.

5. The method of claim 1, wherein said half-toning of said plurality of print image data planes comprises:
receiving said plurality of print image data planes; and
processing each of said plurality of print image data planes with a matrix half-toner algorithm.

6. The method of claim 5, wherein said matrix half-toner algorithm is configured to transform every 8 bit word associated with said plurality of print image data planes into two HiFipe bits, 1 HiFipe bit per pixel.

7. The method of claim 1, wherein said half-toning of said plurality of print image data planes comprises performing one of a matrix half-toner algorithm on said plurality of print image data planes, a Floyd-Stienberg FED half-toner algorithm on said plurality of print image data planes, a PDFED (Plane dependent Fast Error Diffusion) half-toner algorithm on said plurality of print image data planes, or a TDFED (Tone Dependent Fast Error Diffusion) half-toner algorithm on said plurality of print image data planes.

8. The method of claim 1, wherein said plurality (n) of inkjet printheads comprises four stationary inkjet dispensers;
each of said four stationary inkjet dispensers including one of a thermally activated inkjet material dispenser, a mechanically activated inkjet material dispenser, an electrically activated inkjet material dispenser, a magnetically activated material dispenser, or a piezoelectrically activated material dispenser.

9. The method of claim 8, wherein said step of replicating the print image data plane into a plurality of print image data planes corresponding to the plurality of inkjet printheads comprises generating a replica of said received print image data plane in each of a cyan, a yellow, a magenta, and a black (CYMK) resulting plane.

10. The method of claim 1, wherein said steps of receiving print data from a print job source, replicating the print image data plane into a plurality of print image data planes, linearizing said plurality of print image data planes, and half-toning said plurality of print image data planes are performed by an existing application specific integrated circuit (ASIC) of said inkjet printing system.

11. The method of claim 10, wherein said existing ASIC comprises a print data pipeline.

12. A method for printing ink drops from a fixed inkjet printing system having a plurality (n) fixed inkjet print heads comprising:
receiving print data from a print job source including a print image data plane, wherein said received print data comprises data representing a monochrome image;
replicating the print image data plane into a plurality of print image data planes corresponding to the plurality of inkjet printheads;
linearizing said plurality of print image data planes; and
half-toning said plurality of print image data planes;
said half-toning being configured to convert said plurality of print image data planes into a n-plane image with interlaced columns;
said method being performed by an existing application specific integrated circuit (ASIC) of said fixed inkjet printing system.

13. The method of claim 12, wherein said existing ASIC comprises a print data pipeline.

14. The method of claim 12, wherein said step of replicating print image data comprises:
copying each byte of said received print image data plane; and
generating a replica of said received print image data plane (K) in each of a cyan, a yellow, and a magenta (CYM) resulting plane.

15. The method of claim 12, wherein said step of linearizing said plurality of print image data planes comprises:
receiving a plurality of print image data planes;
replacing each value of said plurality of print image data planes with a corresponding value from a lookup table;
wherein each of said plurality of print image data planes has a corresponding lookup table, said corresponding lookup tables being configured to separate said plurality of print image data planes.

16. The method of claim 12, wherein said half-toning of said plurality of print image data planes comprises:
receiving said plurality of print image data planes; and
processing each of said plurality of print image data planes with a matrix half-toner algorithm.

17. The method of claim 16, wherein said matrix half-toner algorithm is configured to transform every 8 bit word associated with said plurality of print image data planes into two HiFipe bits, 1 HiFipe bit per pixel.

18. The method of claim 12, wherein said half-toning of said plurality of print image data planes comprises performing one of a matrix half-toner algorithm on said plurality of print image data planes, a Floyd-Stienberg FED half-toner algorithm on said plurality of print image data planes, a PDFED (Plane dependent Fast Error Diffusion) half-toner algorithm on said plurality of print image data planes, or a TDFED (Tone Dependent Fast Error Diffusion) half-toner algorithm on said plurality of print image data planes.

19. The method of claim 12, wherein said plurality (n) of fixed inkjet printheads comprises four stationary inkjet dispensers;
each of said four stationary inkjet dispensers including one of a thermally activated inkjet material dispenser, a mechanically activated inkjet material dispenser, an electrically activated inkjet material dispenser, a magnetically activated material dispenser, or a piezoelectrically activated material dispenser.

20. The method of claim 19, wherein said step of replicating the print image data plane into a plurality of print image data planes corresponding to the plurality of inkjet printheads comprises generating a replica of said received print image data plane (K) in each of a cyan, a yellow, and a magenta (CYM) resulting plane.

21. A method for splitting a print image data plane for printing with multiple printheads comprising:
replicating the print image data plane into a plurality of print image data planes corresponding to the multiple printheads;
linearizing said plurality of print image data planes; and
half-toning said plurality of print image data planes;
said half-toning being configured to convert said plurality of print image data planes into a n-plane image with interlaced columns, wherein n corresponds to said multiple printheads.

22. The method of claim 21 wherein said step of replicating print image data comprises:
copying each byte of said received print image data plane; and
generating a replica of said received print image data plane in a plurality of resulting planes corresponding to said number of multiple printheads.

23. The method of claim 22, wherein said generating a replica of said received print image data plane comprises generating a replica of said received print image data plane (K) in each of a cyan, a yellow, and a magenta (CYM) resulting plane.

24. The method of claim 21, wherein said step of linearizing said plurality of print image data planes comprises:
receiving a plurality of print image data planes;
replacing each value of said plurality of print image data planes with a corresponding value from a lookup table;
wherein each of said plurality of print image data planes has a corresponding lookup table, said corresponding lookup tables being configured to separate said plurality of print image data planes.

25. The method of claim 21, wherein said half-toning of said plurality of print image data planes comprises:
receiving said plurality of print image data planes; and
processing each of said plurality of print image data planes with a matrix half-toner algorithm.

26. The method of claim 25, wherein said matrix half-toner algorithm is configured to transform every 8 bit word associated with said plurality of print image data planes into two HiFipe bits, 1 HiFipe bit per pixel.

27. The method of claim 21, wherein said half-toning of said plurality of print image data planes comprises performing one of a matrix half-toner algorithm on said plurality of print image data planes, a Floyd-Stienberg FED half-toner algorithm on said plurality of print image data planes, a PDFED (Plane dependent Fast Error Diffusion) half-toner algorithm on said plurality of print image data planes, or a TDFED (Tone Dependent Fast Error Diffusion) half-toner algorithm on said plurality of print image data planes.

28. The method of claim 21, wherein said multiple printheads comprises four stationary inkjet dispensers;
each of said four stationary inkjet dispensers including one of a thermally activated inkjet material dispenser, a mechanically activated inkjet material dispenser, an electrically activated inkjet material dispenser, a magnetically activated material dispenser, or a piezoelectrically activated material dispenser.

29. The method of claim 28, wherein said step of replicating the print image data plane into a plurality of print image data planes corresponding to the plurality of inkjet printheads comprises generating a replica of said received print image data plane (K) in each of a cyan, a yellow, and a magenta (CYM) resulting plane.

30. The method of claim 21, wherein said steps of replicating the print image data plane into a plurality of print image data planes, linearizing said plurality of print image data planes, and half-toning said plurality of print image data planes are performed by an existing application specific integrated circuit (ASIC) of an inkjet printing system.

31. The method of claim 30, wherein said existing ASIC comprises a print data pipeline.

32. An inkjet printing system comprising:
a controller; and
a plurality of printheads communicatively coupled to said controller;
wherein said controller includes an application specific integrated circuit (ASIC) configured to receive print data from a print job source including a print image data plane, replicate the print image data plane into a plurality of print image data planes corresponding to the plurality of printheads, linearize said plurality of print image data planes, and perform a half-toning operation on said plurality of print image data planes to convert said plurality of print image data planes into a n-plane image with interlaced columns, wherein n corresponds to said plurality of printheads.

33. The inkjet printing system of claim 32, further comprising a computing device communicatively coupled to said controller, wherein said computing device is configured to generate said print data.

34. The inkjet printing system of claim 32, wherein said received print data comprises data representing a monochrome image.

35. The inkjet printing system of claim 32, wherein said plurality of printheads comprise fixed inkjet printheads.

36. The inkjet printing system of claim 32, wherein said step of replicating print image data comprises:
copying each byte of said received print image data plane; and
generating a replica of said received print image data plane (K) in each of a cyan, a yellow, and a magenta (CYM) resulting plane.

37. The inkjet printing system of claim 32, wherein said step of linearizing said plurality of print image data planes comprises:
receiving a plurality of print image data planes;
replacing each value of said plurality of print image data planes with a corresponding value from a lookup table;
wherein each of said plurality of print image data planes has a corresponding lookup table, said corresponding lookup tables being configured to separate said plurality of print image data planes.

38. The inkjet printing system of claim 32, wherein said half-toning of said plurality of print image data planes comprises:
receiving said plurality of print image data planes; and
processing each of said plurality of print image data planes with a matrix half-toner algorithm.

39. The inkjet printing system of claim 38, wherein said matrix half-toner algorithm is configured to transform every 8 bit word associated with said plurality of print image data planes into two HiFipe bits, 1 HiFipe bit per pixel.

40. The inkjet printing system of claim 32, wherein said half-toning of said plurality of print image data planes comprises performing one of a matrix half-toner algorithm on said plurality of print image data planes, a Floyd-Stienberg FED half-toner algorithm on said plurality of print image data planes, a PDFED (Plane dependent Fast Error Diffusion) half-toner algorithm on said plurality of print image data planes, or a TDFED (Tone Dependent Fast Error Diffusion) half-toner algorithm on said plurality of print image data planes.

41. The inkjet printing system of claim 32, wherein said plurality of inkjet printheads comprises four stationary inkjet dispensers;
each of said four stationary inkjet dispensers including one of a thermally activated inkjet material dispenser, a mechanically activated inkjet material dispenser, an electrically activated inkjet material dispenser, a magnetically activated material dispenser, or a piezoelectrically activated material dispenser.

42. The inkjet printing system of claim 41, wherein said step of replicating the print image data plane into a plurality of print image data planes corresponding to the plurality of inkjet printheads comprises generating a replica of said received print image data plane (K) in each of a cyan, a yellow, and a magenta (CYM) resulting plane.

43. The inkjet printing system of claim 32, wherein said steps of receiving print data from a print job source, replicating the print image data plane into a plurality of print image data planes, linearizing said plurality of print image data planes, and half-toning said plurality of print image data planes are performed by an existing application specific integrated circuit (ASIC) of said inkjet printing system.

44. The inkjet printing system of claim 43, wherein said existing ASIC comprises a print data pipeline.

45. A means for printing an image comprising:
a means for controlling a printing operation of said inkjet printing system; and
a plurality of means for selectively dispensing ink communicatively coupled to said means for controlling;
wherein said means for controlling includes a means for processing data configured to receive print data from a print job source including a print image data plane, replicate the print image data plane into a plurality of print image data planes corresponding to the plurality of printheads, linearize said plurality of print image data planes, and perform a half-toning operation on said plurality of print image data planes to convert said plurality of print image data planes into a n-plane image with interlaced columns, wherein n corresponds to said plurality of printheads.

46. The image printing means of claim 45, wherein said plurality of means for selectively dispensing ink comprises a plurality of inkjet printheads.

47. The image printing means of claim 46, wherein said inkjet printheads comprise fixed inkjet printheads.

48. The image printing means of claim 45, wherein said means for processing data comprises an application specific integrated circuit (ASIC).
